(19) United States
(12) Patent Application Publication
(10) Pub. No.: US 2014/0270197 A1
(43) Pub. Date: Sep. 18, 2014

(54) LOW POWER AUDIO TRIGGER VIA INTERMITTENT SAMPLING

(71) Applicants: Lakshman Krishnamurthy, Portland, OR (US); Michael E. Deisher, Hillsboro, OR (US); Francis M. Tharappel, Portland, OR (US); Prabhakar R. Datta, Portland, OR (US)

(72) Inventors: Lakshman Krishnamurthy, Portland, OR (US); Michael E. Deisher, Hillsboro, OR (US); Francis M. Tharappel, Portland, OR (US); Prabhakar R. Datta, Portland, OR (US)

(21) Appl. No.: 13/841,166

(22) Filed: Mar. 15, 2013

(51) Int. Cl. H04R 3/00

(52) U.S. Cl. CPC H04R 3/00
USPC 381/56

(57) ABSTRACT

Systems and methods may provide for using an audio front end of a mobile device to sampled audio from an audio signal during a first portion of a periodic detection window, and reducing a power consumption of one or more components of the audio front end during a second portion of the periodic detection window. Additionally, a determination may be made as to whether voice activity is present in the audio signal based at least in part on the sampled audio. In one example, the length of the first portion and the length of the second portion are defined by a duty cycle of the periodic detection window.

### TECHNICAL FIELD

Embodiments generally relate to mobile devices. More particularly, embodiments relate to the use of low power voice triggers to initiate interaction with mobile devices.

### BACKGROUND

Hands-free operation of mobile devices may be relevant in a variety of contexts such as in-vehicle operation and disability-related usage scenarios. Initiating mobile device interactivity in a hands-free setting, however, may present a number of challenges. For example, conventional solutions may designate a pre-arranged activation phrase (e.g., “hey computer”) that enables a speech-based user interface for further interaction, wherein audio may be sampled continuously for analysis by a phrase recognizer until the activation phrase is detected. Such an approach may increase power consumption and have a negative impact on battery life.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a voice trigger architecture according to an embodiment;

FIG. 2 is a plot of an example of voice trigger accuracy versus voice activity detector onset duration for a variety of frame sizes according to an embodiment;

FIG. 3 is a flowchart of an example of a method of initiating interaction with a mobile device according to an embodiment; and

FIG. 4 is block diagram of an example of a mobile device according to an embodiment.

### DESCRIPTION OF EMBODIMENTS

Turning now to FIG. 1, a low power voice trigger architecture 24 is shown. The architecture 24 may generally be used to enable detection of the onset of voice interactions with a mobile device in a hands-free setting (e.g., without the user pushing buttons or otherwise touching the mobile device). In the illustrated example, an audio front end 10 includes a microphone 12, an analog to digital (A/D) converter 14, memory 16, a voice activity detector (VAD) 18 and a phrase recognizer 20. As will be discussed in greater detail, a window such as a periodic detection window may be established by a power management module 22 (e.g., including power management logic) for the architecture 24, wherein the periodic detection window has a duty cycle that defines an active portion (e.g., sampled frame) of the periodic detection window and an inactive portion (e.g., dropped frame) of the periodic detection window. Of particular note is that the inactive portion may enable substantial power savings and extended battery life for the mobile device.

More particularly, during the active portion of the periodic detection window, the audio front end 10 may be used to obtain sampled audio from an audio signal captured by the microphone 12. In such a case, the A/D converter 14 may sample the audio signal at a particular sample rate (e.g., x samples per second) to obtain the sampled audio (e.g., N milliseconds of audio data) for each active portion/sampled frame of the periodic detection window.

During the inactive portion of the periodic detection window, on the other hand, the audio front end 10 may forego any sampling of the audio signal and the power management module 22 may reduce the power consumption of one or more components of the audio front end 10. For example, the power management module 22 might power off the microphone 12, A/D converter 14, voice activity detector 18 and/or phrase recognizer 20, place the memory 16 in self-refresh mode, and so forth, during the inactive portion of the periodic detection window. Thus, the front end 10 may sample the audio signal for an odd N milliseconds, then “sleep” for an even N milliseconds during each periodic detection window. Of particular note is that reducing the power consumption of the components of the audio front end 10 during the inactive portion of the periodic detection window may significantly extend battery life for the mobile device.

In one example, overhead associated with power up and power down operations may be taken into consideration when determining the length of the sampled frame (i.e., active portion of the periodic detection window) and dropped frame (i.e., inactive portion of the periodic detection window). For example, the length of the sampled frame (e.g., sampled frame length) may be selected to be substantially greater than any overhead duration associated with power up operations of the audio front end 10 in order to ensure that energy savings are not negated by the duty cycling approach described herein. Similarly, the length of the dropped frame (e.g., dropped frame length) may be selected to be substantially greater than any overhead duration associated with power down operations of the audio front end 10. In this regard, the duty cycle of the periodic detection window may be fifty percent, or some other value, depending upon the circumstances. For example, if the power down overhead is low relative to the power up overhead, the duty cycle might be increased to a value greater than fifty percent in order to increase the sampled frame length and further optimize power savings.

The sampled audio may be buffered in the memory 16, wherein the illustrated voice activity detector 18 determines whether voice activity is present in the audio signal based at least in part on the sampled audio. Thus, the illustrated voice activity detector 18 may make the activity decision based on the odd N millisecond frames obtained during the active portions of the periodic detection windows. If voice activity is detected, the phrase recognizer 20 may analyze the sampled audio to determine whether a pre-arranged activation phrase is present in the audio signal.

FIG. 2 shows a plot 26 of voice trigger accuracy versus VAD onset duration for a variety of sampled frame sizes. The VAD onset duration may correspond to the size of a buffer memory such as, for example, the memory 16 (e.g., amount of buffering) used to store sampled audio obtained according to a duty cycle as described herein. The plot 26 demonstrates that for sampled frame sizes up to 40 milliseconds and onset durations of up to 160 milliseconds, accuracy degradation may be acceptable (e.g., within 2%), in the illustrated example.

Turning now to FIG. 3, a method 30 of initiating interaction with a mobile device is shown. The method 30 may be implemented in a mobile device as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 30 may be written in any combination of one or more programming languages, including an object oriented programming language such as Java, Smalltalk, C++ or the like and conventional procedural programming languages, such as the “C” programming language or similar programming languages.

Illustrated processing block 32 uses an audio front end of the mobile device to obtain sampled audio from an audio signal during a first portion of a periodic detection window. The power consumption of one or more components of the audio front end may be reduced at block 34 during a second portion of the periodic detection window, wherein a determination may be made at block 36 as to whether voice activity is present in the audio signal based at least in part on the sampled audio. If so, illustrated block 38 continually samples the audio signal (e.g., discontinues duty cycle sampling) in order to increase accuracy for phrase detection purposes. Otherwise, the process may repeat until voice activity is detected.

FIG. 4 shows a mobile device 40. The mobile device 40 may be part of a platform having computing functionality (e.g., personal digital assistant/PDA, laptop, smart tablet), communications functionality (e.g., wireless smart phone), imaging functionality, media playing functionality (e.g., smart television/TV), or any combination thereof (e.g., mobile Internet device/MID). In the illustrated example, the device 40 includes a battery 58 to provide power to the device 40 and a processor 42 having an integrated memory controller (IMC) 44, which may communicate with system memory 46. The system memory 46 may include, for example, dynamic random access memory (DRAM) configured as one or more memory modules such as, for example, dual inline memory modules (DIMMs), small outline DIMMs (SODIMMs), etc.

The illustrated device 40 also includes an input output (IO) module 48, sometimes referred to as a Southbridge of a chipset, that functions as a host device and may communicate with, for example, an audio codec 50, a microphone 52, one or more speakers 54, and mass storage 56 (e.g., hard disk drive/HDD, optical disk, flash memory, etc.). The audio codec 50, microphone 52, IO module 48, etc., may be part of an audio front end such as, for example, the audio front end 10 (FIG. 1), already discussed. The illustrated processor 62, which may function similar to a power management module such as, for example, the power management module 22 (FIG. 1), may execute logic 60 that is configured to use the audio front end to obtain sampled audio from an audio signal during a first portion of a periodic detection window. The logic 60 may also reduce the power consumption of one or more components of the audio front end during a second portion of the periodic detection window, and determine whether voice activity is present in the audio signal based at least in part on the sampled audio. The logic 60 may alternatively be implemented externally to the processor 42. Additionally, the processor 42 and the IO module 48 may be implemented together on the same semiconductor die as a system on chip (SoC).

### Additional Notes and Examples

Example one may include a mobile device having a battery to power the mobile device, an audio front end and logic to use the audio front end to obtain sampled audio from an audio signal during a first portion of a periodic detection window. The logic may also reduce a power consumption of one or more components of the audio front end during a second portion of the periodic detection window, and determine whether voice activity is present in the audio signal based at least in part on the sampled audio.

Additionally, the mobile device of example one may include a power management module that at least partially includes the logic.

Example two may include an apparatus having logic to use an audio front end of a mobile device to obtain sampled audio from an audio signal during a first portion of a periodic detection window. The logic may also reduce a power consumption of one or more components of the audio front end during a second portion of the periodic detection window, and determine whether voice activity is present in the audio signal based at least in part on the sampled audio.

Additionally, a length of the first portion and a length of the second portion are to be defined by a duty cycle of the window in examples one or two. In addition, the first portion is to be greater than a first overhead duration associated with one or more power up operations of the audio front end and the second portion is to be greater than a second overhead duration associated with one or more power down operations of the audio front end. Additionally, the logic of examples one or two may sample the audio signal at a sample rate to obtain the sampled audio. In addition, the logic of examples one or two may store the sampled audio to a memory of the audio front end. Additionally, the logic of examples one or two may sample the audio signal continually if voice activity is present in the audio signal. In addition, the power consumption in examples one or two of one or more of a microphone, a voice activity detector, an analog to digital converter, a memory and a phrase recognizer may be reduced during the second portion of the window.

Example three may include a non-transitory computer readable storage medium having a set of instructions which, if executed by a processor, cause a mobile device to use an audio front end of the mobile device to obtain sampled audio from an audio signal during a first portion of a periodic detection window. The instructions, if executed, may also cause the mobile device to reduce a power consumption of one or more components of the audio front end during a second portion of the periodic detection window, and determine whether voice activity is present in the audio signal based at least in part on the sampled audio.

Additionally, a length of the first portion and a length of the second portion may be defined by a duty cycle of the window in example three. In addition, the first portion of example three may be greater than a first overhead duration associated with one or more power up operations of the audio front end and the second portion of example three may be greater than a second overhead duration associated with one or more power down operations of the audio front end. Additionally, the instructions of example three, if executed, may cause the mobile device to sample the audio signal at a sample rate to obtain the sampled audio. In addition, the instructions of example three, if executed, may cause the mobile device to store the sampled audio to a memory of the audio front end. Additionally, the instructions of example three, if executed, may cause the mobile device to sample the audio signal continually if voice activity is present in the audio signal. In addition, the power consumption in example three of one or more of a microphone, a voice activity detector, an analog to digital converter, a memory and a phrase recognizer may be reduced during the second portion of the window.

Example four may involve a computer implemented method in which an audio front end of a mobile device is used to sampled audio from an audio signal during a first portion of a periodic detection window. The method may also provide for reducing a power consumption of one or more components of the audio front end during a second portion of the periodic detection window, and determining whether voice activity is present in the audio signal based at least in part on the sampled audio.

Additionally, in the method of example four, a length of the first portion and a length of the second portion may be defined by a duty cycle of the window. In addition, in the method of example four, the first portion may be greater than a first overhead duration associated with one or more power up operations of the audio front end and the second portion may be greater than a second overhead duration associated with one or more power down operations of the audio front end. Additionally, the method of example four may further include sampling the audio signal at a sample rate to obtain the sampled audio. In addition, in the method of example four, the power consumption of one or more of a microphone, a voice activity detector, an analog to digital converter, a memory and a phrase recognizer may be reduced during the second portion of the window.

Thus, techniques described herein may enable longer battery life for mobile devices operating in standby mode for voice trigger detection. As a result, hands-free operation may be significantly enhanced a variety of contexts such as, for example, in-vehicle operation (e.g., greater safety) and disability-related usage scenarios.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A mobile device comprising:
a battery to power the mobile device;
an audio front end; and
logic to,
use the audio front end to obtain sampled audio from an audio signal during a first portion of a window;
reduce a power consumption of one or more components of the audio front end during a second portion of the window; and
determine whether voice activity is present in the audio signal based at least in part on the sampled audio.

2. The mobile device of claim 1, wherein a length of the first portion and a length of the second portion are to be defined by a duty cycle of the window.

3. The mobile device of claim 1, wherein the first portion is to be greater than a first overhead duration associated with one or more power up operations of the audio front end and the second portion is to be greater than a second overhead duration associated with one or more power down operations of the audio front end.

4. The mobile device of claim 1, wherein the logic is to sample the audio signal at a sample rate to obtain the sampled audio.

5. The mobile device of claim 1, further including a power management module that at least partially includes the logic.

6. The mobile device of claim 1, wherein the audio front end includes one or more of a microphone, a voice activity detector, an analog to digital converter, a memory and a phrase recognizer.

7. An apparatus comprising:
logic at least partially comprising hardware logic to,
use an audio front end of a mobile device to obtain sampled audio from an audio signal during a first portion of a window;
reduce a power consumption of one or more components of the audio front end during a second portion of the window; and
determine whether voice activity is present in the audio signal based at least in part on the sampled audio.

8. The apparatus of claim 7, wherein a length of the first portion and a length of the second portion are to be defined by a duty cycle of the window.

9. The apparatus of claim 7, wherein the first portion is to be greater than a first overhead duration associated with one or more power up operations of the audio front end and the second portion is to be greater than a second overhead duration associated with one or more power down operations of the audio front end.

10. The apparatus of claim 7, wherein the logic is to sample the audio signal at a sample rate to obtain the sampled audio.

11. The apparatus of claim 7, wherein the logic is to store the sampled audio to a memory of the audio front end.

12. The apparatus of claim 7, wherein the logic is to sample the audio signal continually if voice activity is present in the audio signal.

13. The apparatus of claim 7, wherein the power consumption of one or more of a microphone, a voice activity detector, an analog to digital converter, a memory and a phrase recognizer is to be reduced during the second portion of the window.

14. A non-transitory computer readable storage medium comprising a set of instructions which, if executed by a processor, cause a mobile device to:
use an audio front end of the mobile device to obtain sampled audio from an audio signal during a first portion of a window;
reduce a power consumption of one or more components of the audio front end during a second portion of the window; and
determine whether voice activity is present in the audio signal based at least in part on the sampled audio.

15. The medium of claim 14, wherein a length of the first portion and a length of the second portion are to be defined by a duty cycle of the window.

16. The medium of claim 14, wherein the first portion is to be greater than a first overhead duration associated with one or more power up operations of the audio front end and the second portion is to be greater than a second overhead duration associated with one or more power down operations of the audio front end.

17. The medium of claim 14, the instructions, if executed, cause the mobile device to sample the audio signal at a sample rate to obtain the sampled audio.

18. The medium of claim 14, wherein the instructions, if executed, cause the mobile device to store the sampled audio to a memory of the audio front end.

19. The medium of claim 14, wherein the instructions, if executed, cause the mobile device to sample the audio signal continually if voice activity is present in the audio signal.

20. The medium of claim 14, wherein the power consumption of one or more of a microphone, a voice activity detector, an analog to digital converter, a memory and a phrase recognizer is to be reduced during the second portion of the window.

21. A computer implemented method comprising:
using an audio front end of a mobile device to sampled audio from an audio signal during a first portion of a window;
reducing a power consumption of one or more components of the audio front end during a second portion of the window; and
determining whether voice activity is present in the audio signal based at least in part on the sampled audio.

22. The method of claim 21, wherein a length of the first portion and a length of the second portion are defined by a duty cycle of the window.

23. The method of claim 21, wherein the first portion is greater than a first overhead duration associated with one or more power up operations of the audio front end and the second portion is greater than a second overhead duration associated with one or more power down operations of the audio front end.

24. The method of claim 21, further including sampling the audio signal at a sample rate to obtain the sampled audio.

25. The method of claim 21, wherein the power consumption of one or more of a microphone, a voice activity detector, an analog to digital converter, a memory and a phrase recognizer is reduced during the second portion of the window.
